(19) United States
(12) Patent Application Publication
(10) Pub. No.: US 2025/0360680 A1
(43) Pub. Date: Nov. 27, 2025

(54) SEGMENTED TOOLS HAVING THERMAL EXPANSION ABATEMENT

(71) Applicant: The Boeing Company, Arlington, VA (US)

(72) Inventors: Marc R. Matsen, Seattle, WA (US); Gwendolyn M. Janda, Seattle, WA (US)

(21) Appl. No.: 18/671,809

(22) Filed: May 22, 2024

(51) Int. Cl. B29C 70/44; B29C 33/04; B29C 33/06; B29C 33/08

(52) U.S. Cl. CPC B29C 70/446; B29C 33/04; B29C 33/06; B29C 33/08

(57) ABSTRACT

Systems and methods for manufacturing composite parts may include preheating a tool having a base made of a first material having a first coefficient of thermal expansion and a tooling surface made of a second material having a second coefficient of thermal expansion. Preheating includes heating the tooling surface at a first rate using a first heating system and heating the base at a second rate using a second heating system. Differences in dimensional growth due to thermal expansion of the base and the tooling surface are compensated by spaced-apart box structures coupling the tooling surface to the base, each of the box structures being made of the second material and having a first end fastened to the base and a second end fastened to a back side of the tooling surface.

### FIELD

The present disclosure relates to a tool or mold for manufacturing composite parts, such as the forming and curing of carbon fiber parts.

### BACKGROUND

Composite parts are typically manufactured using a layup process with specialized tools and equipment. For example, carbon fiber layers may be laid up on a mold or a tool, with each ply oriented in the direction that will provide the desired strength and stiffness properties. The laid-up part may then be placed under vacuum to remove air and compact the layers together. The part and tool are placed in an autoclave to cure the resin that binds the carbon fibers together. After curing, the part is removed from the tool and finished, e.g., by trimming and/or sanding.

### SUMMARY

The curing of composite parts can involve relatively high pressure (e.g., several atmospheres) and temperature (e.g., 350 F). Accordingly, it is advantageous to preheat the tooling or mold as well. In some examples, a heated press is used instead of an autoclave, and the tooling can be preheated in these situations. Operations such as thermoplastic stamp-forming may involve heated tooling. Examples of such stamp-forming systems are described in U.S. patent application Ser. No. 18/474,073, filed on Sep. 25, 2023, which is hereby incorporated herein for all purposes. The present disclosure describes systems and methods for dealing with thermally induced stresses associated with tooling having an integrally heated surface, where the base of the tool is a different material than the working surface or platen.

Aspects of the present disclosure may be utilized to improve both accelerated processing of thermoset composites and stamp-forming of thermoplastic composites. Regarding the accelerated processing of thermosets, at least two situations may be benefitted. First, systems and methods of the present disclosure may be used in a non-heated autoclave where the tool surface and part are rapidly heated by induction heating and pressure is applied by the pressurized vessel. Second, systems and methods of the present disclosure may be used to facilitate a double vacuum debulk system where there is no need for an autoclave for pressurization.

When utilizing large and continuous heated metal tooling surfaces, it is important to address the resulting thermally induced stress in the tool overall. Especially in tooling comprising more than one material, this can be quite important in maintaining the tool surface dimensional integrity and resulting part accuracy.

The present disclosure includes systems and methods of segmenting the tool structure into units that are fastened to a base that can grow and shrink in concert with the heated tool surface thereby minimizing the thermal stress generated when heating the surface of the tool. Tools that integrally heat the surface allow for more rapid processing of composite materials, such as thermoplastic composites. These types of tools hold advantages when more rapid thermal cycles for processing composite structures are desired. These rapid thermal cycles in turn facilitate high-rate composite structure production rates.

In some examples, a tool for forming composite parts may include: a base comprising a first material having a first coefficient of thermal expansion; a tooling surface comprising a second material having a second coefficient of thermal expansion; a first heating system comprising an inductive heating element disposed on a back side of the tooling surface, such that the first heating system is configured to heat the tooling surface independent of the base; and a plurality of hollow box structures comprising the second material, each of the box structures having a first end fastened to the base and a second end fastened to a back side of the tooling surface; wherein each of the hollow box structures is spaced apart from neighboring box structures, such that each box structure is configured to expand independently of the other box structures when heated.

In some examples, a tool for forming composite parts may include: a base comprising a first material; a tooling surface comprising a second material and having a first face configured to receive composite materials; a first heating system having one or more inductive heating elements coupled to the tooling surface; a second heating system coupled to the base; a controller configured to independently adjust a respective rate of temperature change of each of the first and second heating systems; and a plurality of spaced apart substructures coupling the tooling surface to the base; wherein each of the substructures has a floor fastened to the base and one or more walls extending from the floor to the tooling surface.

In some examples, a method of manufacturing composite parts may include: preheating a tool having a base comprising a first material having a first coefficient of thermal expansion and a tooling surface comprising a second material having a second coefficient of thermal expansion, wherein preheating comprises: heating the tooling surface at a first rate using a first heating system, and heating the base at a second rate using a second heating system; wherein differences in dimensional growth due to thermal expansion of the base and the tooling surface are compensated by a plurality of spaced-apart box structures coupling the tooling surface to the base, each of the box structures comprising the second material and having a first end fastened to the base and a second end fastened to a back side of the tooling surface.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram (not to scale) depicting a side view of an illustrative segmented tool in a manufacturing environment, in accordance with aspects of the present disclosure.

FIG. 2 is a schematic plan view of a surface portion of an illustrative forming tool of the present disclosure, showing an illustrative arrangement of inductive heating elements on a back side of the surface.

FIG. 3 is a schematic oblique view of a portion of an illustrative forming tool of the present disclosure, showing illustrative segmentation structures.

FIG. 4 is a sectional schematic side view of an illustrative tool in accordance with aspects of the present disclosure.

FIG. 5 is a magnified portion of a substructure wall of the tool of FIG. 4, taken at area A in FIG. 4.

FIG. 6 is a sectional top view of the arrangement of substructures in the tool of FIG. 4, taken at line 6-6 in FIG. 4.

FIG. 7 is a plot of dimensional growth vs. temperature for an illustrative tooling surface and base made of different materials.

FIG. 8 is a block diagram depicting steps of an illustrative method for manufacturing composite parts using a tool of the present disclosure.

FIG. 9 is a block diagram depicting steps of an illustrative method for manufacturing a tool of the present disclosure.

FIG. 10 is a block diagram of an illustrative aircraft manufacturing and service method in accordance with the present teachings.

FIG. 11 is a block diagram of an illustrative aircraft in which an illustrative embodiment may be implemented.

### DETAILED DESCRIPTION

Various aspects and examples of integrally (e.g., inductively) heated tools for manufacturing composite components, as well as related methods, are described below and illustrated in the associated drawings. Unless otherwise specified, a system or apparatus in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

In general, systems of the present disclosure include one or more molds or forming tools configured to be heated (e.g., preheated) by one or more integral heating systems, each of the tools having a base comprising a first material (e.g., aluminum) and a tooling surface in the form of a plate comprising a second material (e.g., an iron-nickel alloy). The tooling surface has a face configured to receive composite materials thereon. To mitigate the difference in thermal expansion between the tooling surface and the base, a support structure or frame of the tool includes spaced-apart, boxlike substructures coupling the tooling surface to the base. Each of these substructures may be made of the same material as the tooling surface. Each of the substructures has a floor fastened to the base (e.g., by a floating fastener), and one or more walls extending from the floor to the tooling surface. In some cases, the floor is absent and only the one or more walls are present. For example, a substructure may have four contiguous walls extending from the base to the tooling structure. In some examples, to provide compression resistance and/or insulate portions of the tool from heat, a solid infill (e.g., a cast ceramic) is disposed in one or more of the cavities formed by the boxlike substructures. Generally speaking, infilling is optional depending on the composite material processing technique. Infill may be useful for thermoplastic molding or stamp forming, for example. However, when used in a non-heated autoclave or when using double vacuum debulk methods the infill is unnecessary.

The tooling surface and the tool base may utilize separate heating systems, such that heating of the different portions of the tool can be controlled independently (e.g., for different rates of heat increase over time during a preheating cycle). In some examples, one or more inductive heating elements are configured to heat the metal plate of the tooling surface while the base is either unheated or heated by a separate inductive, resistive, or water-heating system. In some examples, each of the inductive heating elements of the tooling surface includes a conductor and a susceptor material. For example, a copper conductor may be coated with, coaxial with, wrapped in, wound with, coupled to, and/or intertwined with a susceptor material. In some examples, one or more Litz wires are wound with an Invar® 36 or Invar® 42 susceptor material (or other suitable chemistries) and embedded in or placed adjacent the tooling surface (e.g., on a backside of the surface), forming a self-regulating heating element configured to heat only the forming plate. In some examples, Litz wire wound with smart susceptor wire may be further sheathed (wrapped, wound, etc.) with copper to prevent interaction with the metal tool surface.

Many processes of forming composite parts involve the use of large tools in which the entire tool (e.g., the tooling surface as well as the supporting structure) is heated, such as being preheated before autoclaving, or in forming processes where an autoclave is not used, such as thermoplastic stamp-forming. This method can require a large amount of energy, pose potential safety issues with the changing of tools, and in some cases can require expanded factory space to preheat and stage the tools. Systems and methods of the present disclosure address these issues by using self-regulating induction heaters to rapidly heat only a surface of the tool to operating temperature, while one or more other portions of the tool are unheated, cooled, or heated to a lower temperature.

In some examples of the present disclosure, Litz wires are wound with Invar® 36 smart susceptor wire to create self-regulating heating elements. These heating elements may be installed relative to the heating surface in a manner that provides suitable heat to the tooling surface. In general, closer proximity to the heating surface results in more efficient heating. Accordingly, the heating elements may be disposed against, in direct contact with, or proximate to a back side of the tooling surface. In some examples, the heating elements are disposed partially or wholly within grooves or channels in the back side of the tooling surface. Disposing the heating elements in grooves or channels of the back side of the tooling surface may facilitate isolating the heat energy produced by the heating elements to the surface itself, reducing the transfer of heat energy to the remainder of the tool. If desired or helpful, cast ceramic may be used to fill in the support substructures of the tooling, (1) to help keep the induced heat isolated to the face of the tooling and (2) to resist deformation of the tool face if pressure is to be applied (e.g., during a stamp-forming process). U.S. patent application Ser. No. 18/474,073 (incorporated above) includes further examples and description of suitable heating element and infill arrangements.

Systems of the present disclosure take advantage of the rapid heating and self-regulation of an induction heating circuit including a smart susceptor. In general, alternating current (AC) is passed through a conductor, generating a magnetic field, and a susceptor material is located adjacent to the conductor.

A “susceptor” is a material that converts electromagnetic energy to thermal energy. Susceptors may or may not be ferromagnetic, depending on the application. For example, copper may be used as a susceptor material in some instances. However, so-called “smart susceptors” are ferromagnetic and therefore have high relative magnetic permeability. Smart susceptors remain magnetically permeable until they reach a certain temperature (known as the material's Curie temperature) above which the material becomes non-magnetic. Susceptors of the present disclosure may include any suitable metal, alloy, or other material that is electrically conductive and has a Curie temperature in a range desired for operation of the forming tool. For example, a susceptor may comprise at least one of iron, cobalt, nickel, molybdenum, and/or chromium. For example, the susceptor material Kovar is an iron-nickel-cobalt alloy, and the susceptor material Invar® is an iron-nickel alloy.

The susceptor material runs along a length of the conductor (typically wound around the conductor) and heats up due to induction from the magnetic field caused by the AC current in the nearby conductor. However, the temperature of the susceptor does not rise above the Curie temperature (in practice leveling off at a lower temperature). As the susceptor heats, the thermal profile of the susceptor asymptotically approaches a leveling temperature where the susceptor maintains thermal equilibrium. The leveling temperature is typically a few degrees below the susceptor's Curie temperature (e.g., within 2° F., or within 10° F., or within 50° F., or within 100° F.). If the susceptor begins to cool, its magnetic permeability increases and the heating process begins again. Accordingly, susceptor materials may be selected to achieve a desired operating temperature without needing elaborate temperature controls. The term “smart susceptor” relates to these self-regulating features.

Litz wire is a conductor designed to be efficient for high-frequency applications (e.g., for induction), having a reduced skin effect and a reduced proximity effect. Litz wire includes a plurality of thin strands twisted or braided together. Each strand has a small enough diameter that current is distributed evenly across the strand. Each strand is also insulated from the others to reduce the proximity effect.

In some examples, Litz wires of the present disclosure are shielded by wrapping or encapsulating the smart susceptor-wrapped Litz wire further with a highly conductive material (e.g., copper or aluminum foil, tubing, and/or wire) configured to inhibit direct induction heating of the metallic tool plate in which the heating elements are embedded. U.S. patent application Ser. No. 18/307,478, filed on 26 Apr. 2023 includes suitable examples of such shielded Litz wires, and is hereby incorporated by reference in its entirety.

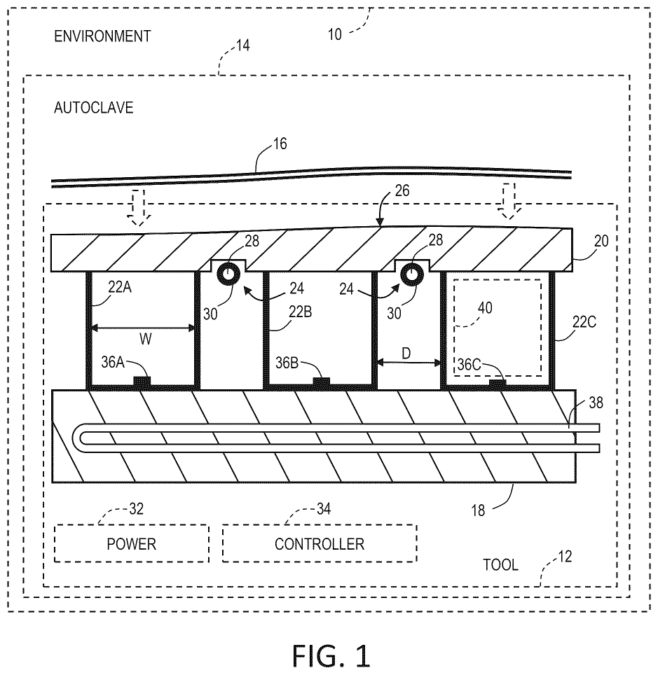

FIG. 1 is a schematic representation of a manufacturing environment 10 for forming composite parts (e.g., components comprising carbon fiber) using one or more heated tools 12. Note that FIG. 1 is a not-necessarily-to-scale diagram provided to facilitate explanation of various representative elements. Manufacturing environment 10 may include any suitable environment in which illustrative embodiments of the present disclosure may be implemented, e.g., to manufacture one or more portions of an aircraft.

Accordingly, environment 10 includes an autoclave 14 configured to provide a heated and pressurized space for at least one heated forming tool 12 to shape and cure a workpiece comprising a composite component 16 (also referred to as a composite part or workpiece).

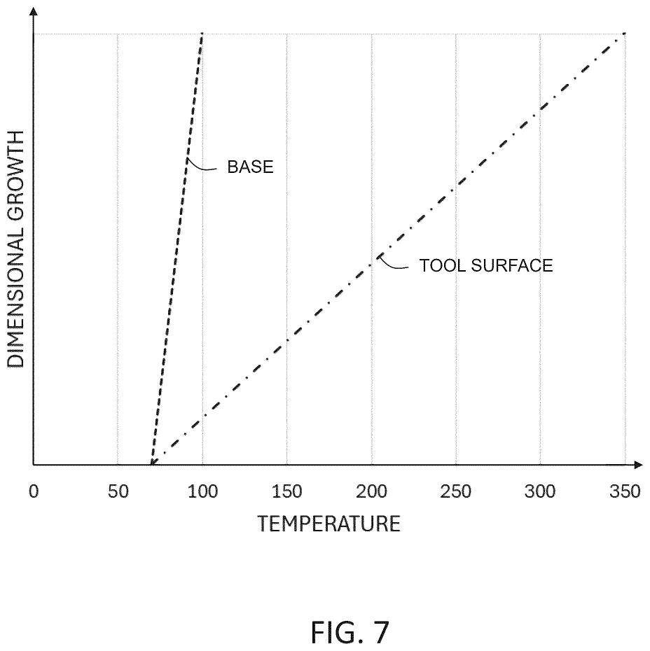

Tool 12 includes a base 18 and a tooling surface 20 (also referred to as a tool surface, a plate, a platen, or a face) coupled to each other by a plurality of boxlike substructures 22A, 22B, 22C. Although three such substructures are depicted in FIG. 1, any suitable number may be utilized. Each of the substructures 22A, 22B, 22C has a plurality of walls extending between base 18 and the back side of tooling surface 20. In some examples, each of the substructures 22A, 22B, 22C has a floor and the plurality of walls reach from the floor to the back side of tooling surface 20. Moreover, each of these substructures comprises the same material as the tooling surface (e.g., an iron-nickel alloy), such that tooling surface 20 and substructures 22A, 22B, 22C have the same coefficient of thermal expansion (CTE). Base 18, however, comprises a different material (e.g., aluminum) having a different coefficient of thermal expansion. Although tool 12 may comprise different structural materials for various reasons, aluminum may be utilized for base 18 because of its relatively high CTE. This higher CTE facilitates reaching the same amount of dimensional expansion at a much lower temperature with respect to tooling surface 20 (see FIG. 7). The desired temperature of base 18 can be easily reached with a lower expenditure of energy using any of various heating methods. Moreover, aluminum has excellent thermal conduction that can facilitate an even thermal distribution in base 18 for more accurate control of the system.

Tooling surface 20 may include any suitable expanse of material configured to be heated and to receive workpiece 16 thereon for part formation and autoclaving. Tooling surface 20 may have a uniform or constant thickness across its expanse (e.g., across the width and/or length of the plate). In some examples, surface 20 has a thickness that varies by location, i.e., having a variable thickness. In some examples, surface 20 has a maximum thickness of approximately one inch. For example, the thickness of surface 20 may be 0.50 inches to 0.75 inches. A front face 26 of surface 20 defines a forming surface of the tool. In some examples, face 26 is planar. In some examples, face 26 has a non-planar profile and/or a three-dimensional contour.

Tooling surface 20 is configured to be heated independently of base 18 by one or more inductive heating elements 24. Heating elements 24 may be disposed in a back side of the tooling surface and/or embedded in the tooling surface. Each inductive heating element 24 comprises a conductor 28 coupled to a susceptor material 30. Conductor 28 may include any suitable conductive material, e.g., copper. In some examples, conductor 28 includes one or more Litz wires. Susceptor material 30 may include any suitable susceptor running along a length of the conductor, and may take any suitable form, such as a wire, a coating, a strand, a sheath, a container, etc. In some examples, susceptor material 30 comprises an iron-nickel alloy (e.g., Invar®, e.g., Invar® 36) or an iron-nickel-cobalt alloy. In some examples, the susceptor is wound (e.g., braided, twisted, plaited, etc.) together with the conductor. In some examples, the susceptor is coated onto the conductor and/or configured as a sheath for the conductor.

Heating element(s) 24 may be disposed in any suitable location configured to heat tooling surface 20 to operating temperature. In some examples, the one or more inductive heating elements are coupled to a rear surface of tooling surface 20 (i.e., a surface of the plate facing away from the forming surface). For example, heating element(s) 24 may be disposed on the rear surface of the plate, as depicted in the example of FIG. 1. In some examples, heating element(s) 24 may be at least partially embedded in the plate., e.g., the heating element(s) may be disposed in one or more channels or grooves.

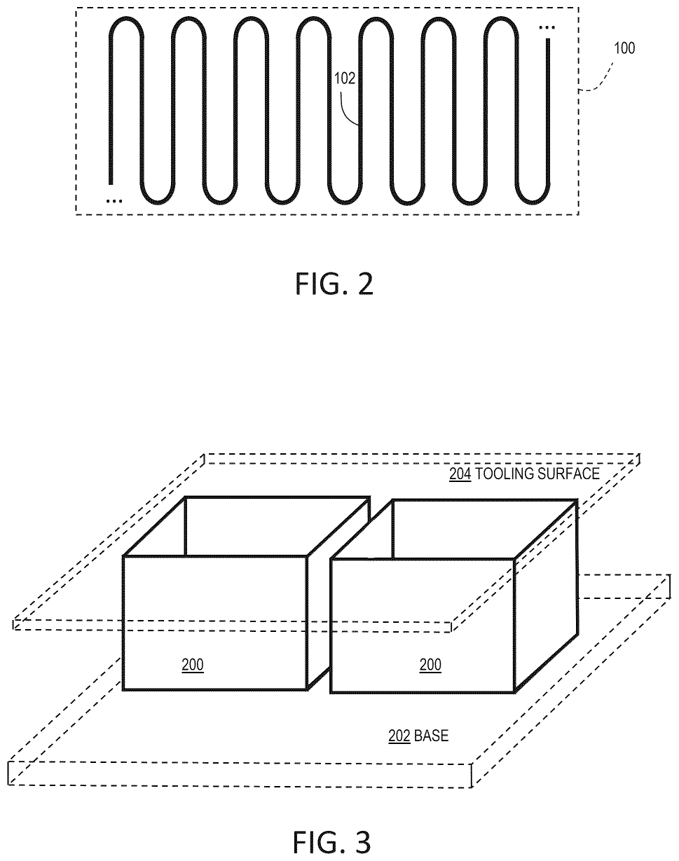

Heating element(s) 24 may be arranged on or adjacent to tooling surface 20 in any suitable manner. For example, a single heating element may extend across all or a portion of the plate. In some examples, one of the heating elements is disposed on a rear surface of the plate in a serpentine or sinusoidal pattern. See heating element 102 on plate 100 of FIG. 2. Different heating elements may be utilized in different portions or zones of the plate, e.g., if more than one temperature is desired. In some examples, multiple heating elements may be installed side by side to provide further heating and/or redundancy. In some cases, different numbers of heating elements may be powered to provide further control of the heating.

Heating elements 24 may be powered by a power supply 32 and controlled by an electronic controller 34, where the power supply and/or controller are either a part of tool 12 or provided by manufacturing environment 10.

Due to being heated separately and/or because of the difference in materials between the tooling surface and the base, thermal stresses are placed on tooling surface 20 if it is not permitted to expand and contract relatively independently with respect to other portions of tool 12, such as base 18. To provide thermal abatement and to mitigate or minimize the effects of such thermal stresses, spaced-apart substructures 22A, 22B, 22C couple the tooling surface to the base. Any number of such substructures may be utilized. In some examples, each of the substructures has the same planform. In some examples, each of the substructures taken in isolation is an open-topped boxlike structure. A floor of each substructure, which may be continuous from wall to wall or which may instead be partial in nature, is coupled (e.g., loosely coupled) to base 18 by a fastener 36A, 36B, 36C. Fasteners 36A, 36B, 36C may include any suitable connector configured to form a joint coupling the floor to the base (e.g., at the center of the floor), such as one or more bolts, pins, screws, adhesives, rivets, welds, and/or the like. In some examples, the joint is loose-fitting, such as the joint formed by a bolt in a slotted opening or an oversized hole. In some examples, the joint is fixed, such as by a weld or rivet.

In examples where one or more substructures do not have a floor, other configurations and attachment techniques may be utilized to fasten the walls to the base. For example, the wall of a substructure may be coupled to the base using one or more brackets, anchors, or plates (e.g., with a loose-fitting joint) or using more fixed mechanisms such as rivets or welds.

As depicted in the example of FIG. 3, each substructure 200 (also referred to as a segment or a cell) is a multi-sided, open-topped boxlike structure extending from a base 202 to a tooling surface 204. The substructures may be cuboidal, cylindrical, or prismatic, having one or more walls, and may be spaced apart to facilitate expansion and contraction of the substructures relative to each other and/or the base. With reference to FIG. 1, each substructure may have a lateral dimension W (e.g., a width), and may be spaced from neighboring substructures by a suitable distance D. In some examples, W is greater than or equal to D. In some examples, W is at least two times D. In some examples, W is at least 3×D, at least 4×D, at least 5×D, at least 10×D, at least 20×D, at least 25×D, at least 50×D, or more. Various factors affect the selection of distance D and width W. For example, the size D of any given segment may be limited to avoid placing too much compressive stress on the area of the tool surface within the border of the segment. In some examples, a thicker tooling surface 20 will lead to a larger cell (i.e., a larger D) since the thicker plate may be more dimensionally stable and require less support. Tooling plate thickness will be influenced by the overall inherent stiffness of the tool geometry. In some examples, the tooling surface is more convoluted and thus stiffer as a whole, such that a larger segment size may be used. The segment size may also depend on the temperature being targeted for the processing system (in general, lower temperatures allow larger segments). Spacing of the substructures from each other may depend on similar factors, as well as an expected amount of dimensional change, e.g., preventing the segment walls from interfering with each other.

To facilitate heating of the entire tool 12, base 18 may have an independent heat source 38. Heat source 38 may include any suitable heater, including water heating, electric resistance heating, and/or the like. Heat source 38 may be utilized in conjunction with heating element(s) 24 to heat the various portions of tool 12 to selected respective temperatures to ensure similar thermal expansion and/or contraction and thereby to reduce structural stresses.

In some examples, tool 12 may be utilized in a heated stamping press rather than an autoclaving process. In such examples and others, it may be desirable to reinforce the frame of tool 12 by including an infill material 40 in one or more of the cavities formed by walls of substructures 22A, 22B, 22C. Infill material 40 is configured to provide heat insulation and/or compression resistance. Infill material 40 may include any suitable material configured to have a thermal conductivity lower than the tooling framework and to provide compression resistance at expected operating pressure ranges (e.g., 500 to 750 pounds per square inch (psi)). For example, infill 40 may comprise a cast material, e.g., a cast ceramic.

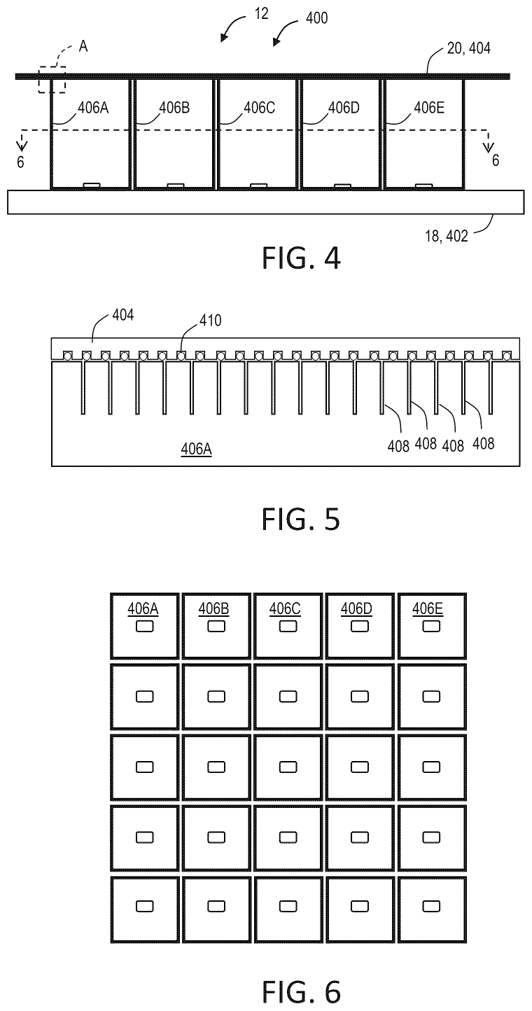

Turning now to FIGS. 4-7, illustrative non-exclusive examples of tool 12 are depicted and described. Where appropriate, the reference numerals from the schematic illustrations of FIG. 1 are used to designate corresponding parts of the tool; however, the examples of FIGS. 4-7 are non-exclusive and do not limit tool 12 to the illustrated embodiments. That is, systems and methods of the present disclosure are not limited to the specific embodiments of FIGS. 4-7, and tool 12 may incorporate any number of the various aspects, configurations, characteristics, properties, etc. that are illustrated in and discussed with reference to the schematic representations of FIG. 1 and/or the embodiments of FIGS. 4-7, as well as variations thereof, without requiring the inclusion of all such aspects, configurations, characteristics, properties, etc. For brevity, each previously discussed component, part, portion, aspect, region, etc. or variants thereof may not be discussed, illustrated, and/or labeled again with respect to FIGS. 4-7; however, it is within the scope of the present disclosure that the previously discussed features, variants, etc. may be utilized with the different embodiments.

FIG. 4 is a sectional schematic side view of a tool 400, which is an example of tool 12 described above. FIG. 5 is a magnified portion of a substructure wall of tool 400 where the wall meets the back side of the tooling surface, taken at area A in FIG. 4. FIG. 6 is a sectional top view of the arrangement of substructures in tool 400, taken at line 6-6 in FIG. 4.

As depicted in FIG. 4, tool 400 includes a base 402, a tooling surface 404, and a plurality of boxlike support substructures 406A, 406B, 406C, 406D, 406E coupling the tooling surface to the base as described above with respect to tool 12. As depicted in the example of FIG. 5, one or more walls of the substructures include a castellated or slotted upper edge. In some examples, slots 408 are formed in the wall of the substructure, e.g., as shown in FIG. 5, to provide further thermal expansion/contraction compliance in the region where the wall meets the back side of tooling surface 404. As depicted in FIG. 5, inductive heating elements 410 may be disposed in this region as well.

FIG. 6 is a top-down view showing an illustrative layout for the segmentation substructures in the present embodiment. As depicted, substructures 406A-406E and their neighbors may be laid out in a regular pattern with a same or similar spacing between the individual segments. In some examples, more or fewer segmentation substructures may be utilized. In some examples, one or more segmentation substructures may be omitted or relocated, such that larger gaps exist between some substructures than between others.

As discussed above, the tooling surface and the base comprise different materials, such that the two portions of the tool have different coefficients of thermal expansion. Accordingly, a larger change in temperature will be required for an Invar 36 tooling surface to have the same dimensional growth as an aluminum base. In practice, as the smart susceptor heating elements heat the surface of the tool, the aluminum base is heated separately such that each portion grows at the same rate. The aluminum has a higher coefficient (13×10⁻⁶ per ° F.), growing much faster per degree than the Invar 36 (1.25×10⁻⁶ per ° F.). FIG. 7 is a plot showing the equivalent dimensional growth of the two portions of the tool in this scenario. As the tooling surface is heated from room temperature (˜70 F) to a curing temperature of 350 F, the aluminum base is heated from room temperature to ˜100 F.

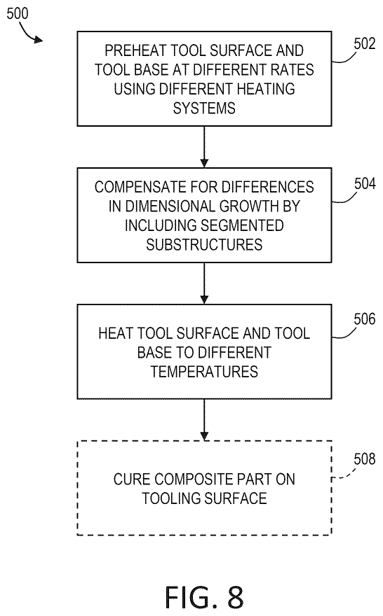

FIG. 8 depicts steps of an illustrative method 500 for manufacturing composite parts and materials. Aspects of the tools and systems described above may be utilized in the method steps described below. Where appropriate, reference may be made to components and systems that may be used in carrying out each step. These references are for illustration, and are not intended to limit the possible ways of carrying out any particular step of the method.

FIG. 8 is a flowchart illustrating steps performed in an illustrative method, and may not recite the complete process or all steps of the method. Although various steps of method 500 are described below and depicted in FIG. 8, the steps need not necessarily all be performed, and in some cases may be performed simultaneously or in a different order than the order shown.

Step 502 of method 500 includes preheating a tool having a base comprising a first material (e.g., aluminum) having a first coefficient of thermal expansion and a tooling surface comprising a second material (e.g., an iron-nickel alloy, such as Invar 36) having a second coefficient of thermal expansion. Preheating includes heating the base at a first rate using a resistive or heated-water heating system, and heating the tooling surface at a second rate using an inductive heating system. Control of the first and/or second heating systems may be performed using an electronic controller (e.g., a same electronic controller, e.g., automatically). The first and second rates may be selected to maintain a same dimensional growth over time between the base and the tooling surface. The inductive heating system of the tooling surface may include inductive heating elements disposed in the back side of the tooling surface. In some examples, the inductive heating elements comprise Litz wire wrapped in a smart susceptor material. In some examples, the heating elements further comprise an outer wrapping of copper or aluminum foil, which may include copper or aluminum braiding or sheathing.

Step 504 of method 500 includes compensating for differences in dimensional growth due to thermal expansion of the base and the tooling surface by including a plurality of spaced-apart box structures coupling the tooling surface to the base, each of the hollow box structures comprising the second material and having a first end fastened to the base and a second end fastened to a back side of the tooling surface.

Step 506 of method 500 includes heating the tooling surface to an operating temperature and heating the base to a second temperature different than the operating temperature. For example, the operating temperature may be approximately 350 F. For example, the second temperature may be approximately 100 F.

Step 508 of method 500 includes curing a composite part disposed on a front side of the tooling surface, e.g., in an autoclave.

In some examples, each of the box structures includes a floor coupled to the base and one or more walls extending from the floor to the back side of the tooling surface. The floor of each of the box structures may be fastened to the base by a fastener spaced from the one or more walls. For example, the fastener may be centered on the respective floor. In some examples, each of the one or more walls has a plurality of thermal expansion slots (e.g., at a top edge). In some examples, one or more of the hollow box structures may be reinforced using a ceramic infill.

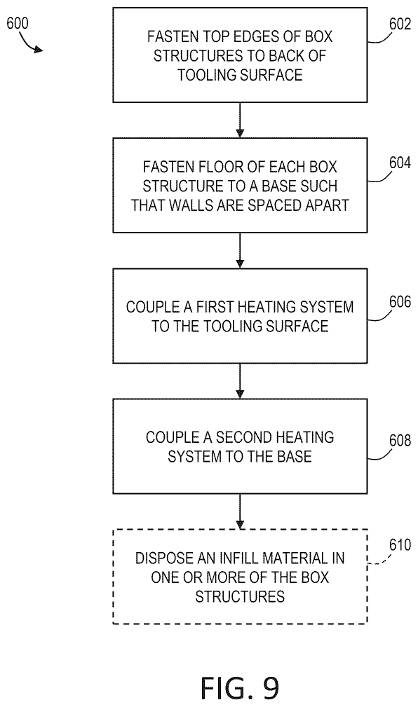

FIG. 9 depicts steps of an illustrative method 600 for manufacturing a tool of the present disclosure, such as tool 12. FIG. 9 is a flowchart illustrating steps performed in an illustrative method, and may not recite the complete process or all steps of the method. Although various steps of method 600 are described below and depicted in FIG. 9, the steps need not necessarily all be performed, and in some cases may be performed simultaneously or in a different order than the order shown.

Step 602 of method 600 includes fastening respective top edges of a plurality of multi-sided, open-topped box structures to a back side of a tooling surface (e.g., by welding), such that each of the box structures extends away from the back side of the tooling surface, wherein the tooling surface and the box structures comprise a same first material (e.g., iron-nickel alloy, such as Invar 36).

Step 604 of method 600 includes fastening a respective floor of each of the box structures to a base comprising a second material, such that the walls of neighboring ones of the box structures are spaced apart from each other. The first material and the second material have different coefficients of thermal expansion. Spacing between the box structures may be selected such that the tooling surface and the base are free to expand at different rates when heated. In some examples, fastening the respective floor of each of the box structures to the base includes using a floating fastener, such as an oversized-or slotted-hole joint. In some examples, fastening the respective floor of each of the box structures to the base includes bolting the floor to the base.

Step 606 of method 600 includes coupling a first heating system to the tooling surface (e.g., to the back side of the tooling surface). For example, the first heating system may include one or more induction heating elements. In some examples, coupling the first heating system to the tooling surface includes installing the one or more induction heating elements in one or more channels or grooves formed in the back side of the tooling surface. In some examples, each of the induction heating elements comprises Litz wire wrapped in a smart susceptor material, optionally further comprising an outer wrapping of copper or aluminum foil.

Step 608 of method 600 includes coupling a second heating system to the base of the tool. For example, the second heating system may include a resistive heating system or a heated water heating system configured to heat the base. In some examples, the second heating system is configured to heat the base at a rate different than the first heating system heats the tooling surface, e.g., controlled by an electronic controller configured to adjust a respective rate of temperature change for each of the heating systems.

Step 610 of method 600 may include disposing an infill material (e.g., ceramic) in a cavity of one or more of the box structures to provide compression resistance to the tool.

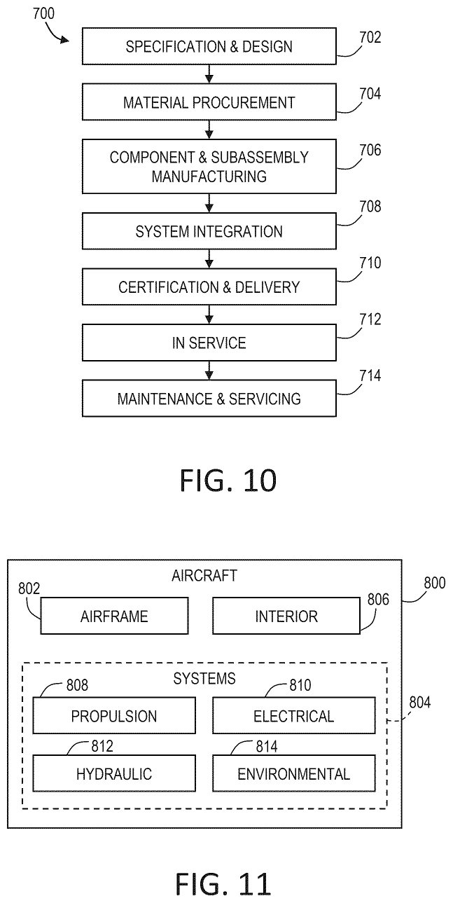

Illustrative embodiments of the present disclosure may be described in the context of an aircraft manufacturing and service method 700 as shown in FIG. 10 and an aircraft 800 as shown in FIG. 11. Turning first to FIG. 10, an illustration of an aircraft manufacturing and service method is depicted in accordance with an illustrative embodiment.

During preproduction, aircraft manufacturing and service method 700 may include specification and design 702 of aircraft 800 and material procurement 704. During production, component and subassembly manufacturing 706 and system integration 708 of aircraft 800 takes place. Thereafter, aircraft 800 may go through certification and delivery 710 in order to be placed in service 712. While in service 712 by a customer, aircraft 800 is scheduled for routine maintenance and service 714, which may include modification, reconfiguration, refurbishment, or other maintenance and service.

Each of the processes of aircraft manufacturing and service method 700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of an aircraft is depicted in which an illustrative embodiment may be implemented. In this example, aircraft 800 is produced by aircraft manufacturing and service method 700 of FIG. 10 and may include airframe 802 with plurality of systems 804 and interior 806. Examples of systems 804 include one or more of propulsion system 808, electrical system 810, hydraulic system 812, and environmental system 814. Any number of other systems may be included.

Apparatuses and methods embodied herein may be employed during at least one of the stages of aircraft manufacturing and service method 700. One or more illustrative embodiments may be manufactured or used during at least one of component and subassembly manufacturing 706, system integration 708, in service 712, or maintenance and service 714 of FIG. 10.

A portion of airframe 802 of aircraft 800 can be formed by method 500 and method 500 can be performed during component and subassembly manufacturing 706. Tool 12 can be used to form a composite structure during component and subassembly manufacturing 706. In some illustrative examples, a composite structure formed using method 500 is present and utilized during in service 712. Method 500 can be performed during maintenance and service 714 to form a replacement part.

Illustrative, non-exclusive examples of inventive subject matter according to the present disclosure are described in the following enumerated paragraphs:
A1. A tool for forming composite parts, the tool comprising:
   a base comprising a first material having a first coefficient of thermal expansion;
   a tooling surface comprising a second material having a second coefficient of thermal expansion; and
   a plurality of hollow box structures comprising the second material, each of the box structures having a first end fastened to the base and a second end fastened to a back side of the tooling surface;
   wherein each of the hollow box structures is spaced apart from neighboring box structures, such that each box structure is configured to expand independently when heated.
A2. The tool of A1, wherein each of the box structures comprises a floor coupled to the base and one or more walls extending from the floor to the back side of the tooling surface.
A3. The tool of A2, wherein each of the one or more walls comprises a plurality of thermal expansion slots.
A4. The tool of A2 or A3, wherein the floor of each of the box structures is fastened to the base by a fastener spaced from the one or more walls.
A5. The tool of A4, wherein the fastener is centered on the respective floor.
A6. The tool of A4 or A5, wherein the fastener comprises a floating fastener.
A7. The tool of A6, wherein the floating fastener comprises an oversized or slotted hole joint.
A8. The tool of any one of A1 through A7, wherein respective top edges of the box structures are welded to the back side of the tooling surface.
A9. The tool of any one of A1 through A8, wherein the respective floor of each of the box structures is bolted to the base.
A10. The tool of any one of A1 through A9, wherein the first material comprises aluminum.
A11. The tool of any one of A1 through A10, wherein the second material comprises an iron-nickel alloy (e.g., Invar 36).
A12. The tool of any one of A1 through A11, further comprising inductive heating elements disposed in the back side of the tooling surface.
A13. The tool of A12, wherein the inductive heating elements comprise Litz wire wrapped in a smart susceptor material.
A14. The tool of A13, wherein the heating elements further comprise an outer wrapping of copper or aluminum foil.
A15. The tool of any one of A1 through A14, further comprising a resistive heating system or a heated water heating system configured to heat the base.
A16. The tool of any one of A1 through A15, further comprising a ceramic infill disposed in each of the hollow box structures.
B1. A tool for forming composite parts, the tool comprising:
   a base comprising a first material;
   a tooling surface comprising a second material and having a first face configured to receive composite materials; and
   a plurality of spaced apart substructures coupling the tooling surface to the base;
   wherein each of the substructures has a floor fastened to the base and one or more walls extending from the floor to the tooling surface.
B2. The tool of B1, wherein the first material comprises aluminum.
B3. The tool of B1 or B2, wherein the second material comprises an iron-nickel alloy (e.g., Invar 36).
B4. The tool of any one of B1 through B3, further comprising an inductive heating system having one or more heating elements coupled to the tooling surface.
B5. The tool of B4, wherein the one or more heating elements include a smart susceptor material wound around a Litz wire, and the one or more heating elements are disposed in a second face of the tooling surface.
B6. The tool of B5, wherein each heating element has an outer wrap comprising a copper or aluminum foil.
B7. The tool of any one of B1 through B6, wherein the plurality of substructures each have a same longitudinal dimension.
B8. The tool of B7, wherein the longitudinal dimension is a width.
B9. The tool of any one of B1 through B8, wherein the respective floor and an adjacent portion of the one or more walls of each of the substructures forms a cuboidal shape.
B10. The tool of B9, wherein the one or more walls of at least one of the substructures includes a plurality of walls of a varying height.
B11. The tool of any one of B1 through B10, wherein the base has a different coefficient of thermal expansion than the tooling surface.
B12. The tool of any one of B1 through B11, wherein a first heating system is coupled to the base and a second heating system is coupled to the tooling surface.
B13. The tool of B12, wherein the first heating system includes resistive heating or heated water.
B14. The tool of B12 or B13, wherein the second heating system is inductive.
B15. The tool of any one of B1 through B14, wherein the tooling surface is flat or planar.
B16. The tool of any one of B1 through B14, wherein the tooling surface has a curvature.
B17. The tool of any one of B1 through B16, wherein the floor of each of the plurality of substructures has a same planform.
B18. The tool of any one of B1 through B17, wherein the floor of each of the plurality of substructures has a same size.
B19. The tool of any one of B1 through B18, wherein the one or more walls of each of the substructures are spaced from neighboring substructures such that each of the substructures is free to expand and contract.
B20. The tool of any one of B1 through B19, wherein the floor of each of the plurality of substructures is fastened to the base by a respective fastener spaced from the one or more walls.
B21. The tool of any one of B1 through B20, wherein each of the one or more walls of the substructures include an edge in contact with the tooling surface, and the edge has a plurality of slots configured to provide thermal expansion compliance.
B22. The tool of any one of B1 through B21, wherein each of the substructures forms a respective cavity.
B23. The tool of B22, further comprising an infill material disposed in one or more of the cavities.
B24. The tool of B23, wherein the infill material comprises a ceramic.
C1. A method of manufacturing composite materials, the method comprising:
   preheating a tool having a base comprising a first material having a first coefficient of thermal expansion and a tooling surface comprising a second material having a second coefficient of thermal expansion, wherein preheating comprises:
      heating the base at a first rate using a resistive or heated-water heating system; and
      heating the tooling surface at a second rate using an inductive heating system;
   wherein differences in dimensional growth due to thermal expansion of the base and the tooling surface are compensated by a plurality of spaced-apart box structures coupling the tooling surface to the base, each of the hollow box structures comprising the second material and having a first end fastened to the base and a second end fastened to a back side of the tooling surface.
C2. The method of C1, further comprising heating the tooling surface to an operating temperature and heating the base to a second temperature different than the operating temperature.
C3. The method of C2, wherein the operating temperature is approximately 350 F.
C4. The method of C3, wherein the second temperature is approximately 100 F.
C5. The method of any one of C1 through C4, wherein the first and second rates are selected to maintain a same dimensional growth over time between the base and the tooling surface.
C6. The method of any one of C1 through C5, further comprising curing a composite part disposed on a front side of the tooling surface.
C7. The method of C6, wherein curing the composite part is performed in an autoclave.
C8. The method of any one of C1 through C7, wherein each of the box structures comprises a floor coupled to the base and one or more walls extending from the floor to the back side of the tooling surface.
C9. The method of C8, wherein the floor of each of the box structures is fastened to the base by a fastener spaced from the one or more walls.
C10. The method of C9, wherein the fastener is centered on the respective floor.
C11. The method of any one of C8 through C10, wherein each of the one or more walls comprises a plurality of thermal expansion slots.
C12. The method of any one of C1 through C11, wherein the first material comprises aluminum.
C13. The method of any one of C1 through C12, wherein the second material comprises an iron-nickel alloy (e.g., Invar 36).
C14. The method of any one of C1 through C13, wherein the inductive heating system comprises inductive heating elements disposed in the back side of the tooling surface.
C15. The method of C14, wherein the inductive heating elements comprise Litz wire wrapped in a smart susceptor material.
C16. The method of C15, wherein the heating elements further comprise an outer wrapping of copper or aluminum foil.
C17. The method of any one of C1 through C16, further comprising reinforcing one or more of the hollow box structures using a ceramic infill.
D1. A method of manufacturing a tool for forming composite parts, the method comprising:
   fastening respective top edges of a plurality of multi-sided, open-topped box structures to a back side of a tooling surface, such that each of the box structures extends away from the back side of the tooling surface, wherein the tooling surface and the box structures comprise a same first material;
   fastening a respective floor of each of the box structures to a base comprising a second material, such that the walls of neighboring ones of the box structures are spaced apart from each other;
   wherein the first material and the second material have different coefficients of thermal expansion, and spacing between the box structures is selected such that the tooling surface and the base are free to expand at different rates when heated.
D2. The method of D1, wherein fastening the respective floor of each of the box structures to the base includes using a floating fastener.
D3. The method of D2, wherein the floating fastener comprises an oversized or slotted hole joint.
D4. The method of D1 wherein fastening the respective top edges of the box structures to the back side of the tooling surface comprises welding.
D5. The method of D1, wherein fastening the respective floor of each of the box structures to the base comprises bolting the floor to the base.
D6. The method of any one of D1 through D5, further comprising coupling a first heating system to the tooling surface (e.g., to the back side of the tooling surface).
D7. The method of D6, wherein the first heating system comprises one or more induction heating elements.
D8. The method of D7, wherein coupling the first heating system to the tooling surface comprises installing the one or more induction heating elements in one or more channels or grooves formed in the back side of the tooling surface.
D9. The method of D7 or D8, wherein each of the induction heating elements comprises Litz wire wrapped in a smart susceptor material, optionally further comprising an outer wrapping of copper or aluminum foil.
D10. The method of any one of D1 through D9, further comprising coupling a second heating system to the base of the tool.
D11. The method of D10, wherein the second heating system comprises a resistive heating system or a heated water heating system configured to heat the base.
D12. The method of D10 or D11, wherein the second heating system is configured to heat the base at a rate different than the first heating system heats the tooling surface.
D13. The method of any one of D1 through D12, further comprising disposing an infill material (e.g., ceramic) in a cavity of one or more of the box structures to provide compression resistance to the tool.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device. “Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAS (field-programmable gate arrays), artificial intelligence (Al) accelerators, digital signal processors (DSPs), and/or any other suitable combination of logic hardware.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A tool for forming composite parts, the tool comprising:
a base comprising a first material having a first coefficient of thermal expansion;
a tooling surface comprising a second material having a second coefficient of thermal expansion;
a first heating system comprising an inductive heating element disposed on a back side of the tooling surface, such that the first heating system is configured to heat the tooling surface independent of the base; and
a plurality of hollow box structures comprising the second material, each of the box structures having a first end fastened to the base and a second end fastened to a back side of the tooling surface;
wherein each of the hollow box structures is spaced apart from neighboring box structures, such that each box structure is configured to expand independently of the other box structures when heated.

2. The tool of claim 1, wherein each of the box structures comprises a floor coupled to the base and one or more walls extending from the floor to the back side of the tooling surface.

3. The tool of claim 2, wherein each of the one or more walls comprises a plurality of thermal expansion slots.

4. The tool of claim 2, wherein the floor of each of the box structures is fastened to the base by a fastener spaced from the one or more walls.

5. The tool of claim 4, wherein the fastener forms a floating joint.

6. The tool of claim 1, wherein the first material comprises aluminum and the second material comprises an iron-nickel alloy.

7. The tool of claim 6, wherein the inductive heating element comprises Litz wire wrapped in a smart susceptor material.

8. The tool of claim 1, further comprising a second heating system configured to heat the base.

9. A tool for forming composite parts, the tool comprising:
a base comprising a first material;
a tooling surface comprising a second material and having a first face configured to receive composite materials;
a first heating system having one or more inductive heating elements coupled to the tooling surface;
a second heating system coupled to the base;
a controller configured to independently adjust a respective rate of temperature change of each of the first and second heating systems; and
a plurality of spaced apart substructures coupling the tooling surface to the base;
wherein each of the substructures has a floor fastened to the base and one or more walls extending from the floor to the tooling surface.

10. The tool of claim 9, wherein the first material comprises aluminum and the second material comprises an iron-nickel alloy.

11. The tool of claim 9, wherein the one or more inductive heating elements include a smart susceptor material wound around a Litz wire, and the one or more inductive heating elements are disposed in a second face of the tooling surface.

12. The tool of claim 9, wherein the second heating system of the base includes resistive heating or heated water.

13. The tool of claim 9, wherein the one or more walls of each of the substructures are spaced from neighboring substructures such that each of the substructures is free to expand and contract.

14. The tool of claim 9, wherein each of the one or more walls of the substructures include an edge in contact with the tooling surface, and the edge has a plurality of slots configured to provide thermal expansion compliance.

15. A method of manufacturing composite parts, the method comprising:
preheating a tool having a base comprising a first material having a first coefficient of thermal expansion and a tooling surface comprising a second material having a second coefficient of thermal expansion, wherein preheating comprises:
heating the tooling surface at a first rate using a first heating system; and
heating the base at a second rate using a second heating system;
wherein differences in dimensional growth due to thermal expansion of the base and the tooling surface are compensated by a plurality of spaced-apart box structures coupling the tooling surface to the base, each of the box structures comprising the second material and having a first end fastened to the base and a second end fastened to a back side of the tooling surface.

16. The method of claim 15, further comprising heating the tooling surface to an operating temperature and heating the base to a second temperature different than the operating temperature.

17. The method of claim 15, wherein the first and second rates are selected to maintain a same dimensional growth over time between the base and the tooling surface.

18. The method of claim 17, further comprising placing the tool in an autoclave and curing a composite part disposed on a front side of the tooling surface.

19. The method of claim 15, wherein each of the box structures comprises a floor coupled to the base and one or more walls extending from the floor to the back side of the tooling surface.

20. The method of claim 15, wherein the first heating system comprises an inductive heating system having one or more inductive heating elements disposed in the back side of the tooling surface, each of the inductive heating elements comprising Litz wire wrapped in a smart susceptor material.
